(19) United States
(12) Patent Application Publication
(10) Pub. No.: US 2024/0284878 A1
(43) Pub. Date: Aug. 29, 2024

(54) MACHINE FOR INJECTING EGGS AND METHOD FOR INJECTING AT LEAST ONE FLUID SUBSTANCE INTO EGGS

(71) Applicant: EGG-CHICK AUTOMATED TECHNOLOGIES, Landivisiau (FR)

(72) Inventors: Florent MENGUY, Landivisiau (FR); Jérôme GUYADER, Landivisiau (FR)

(21) Appl. No.: 18/569,707

(22) PCT Filed: Jun. 16, 2022
(86) PCT No.: PCT/FR2022/051171

§ 371 Date: Dec. 13, 2023

(30) Foreign Application Priority Data
Jun. 18, 2021 (FR) FR2106517

(51) Int. Cl. A01K 45/00

(52) U.S. Cl. CPC A01K 45/007

(57) ABSTRACT

The present invention relates to a method and an injection machine for injecting eggs, in which the machine injects eggs placed in trays, said machine comprising: a first injector set (14) for injecting a fluid substance into a first group of eggs in a first tray and at least one other injector set (16) for injecting a fluid substance into a different group of eggs in another tray, said machine also comprising a treatment line along which the injector sets are arranged, said injector sets (14, 16) being spaced apart from one another such that one injector set treats a single tray at a time, each injector set (14, 16) being configured to simultaneously treat the eggs to be injected in the corresponding egg group, said tray being stationary during the treatment of said egg group by the corresponding injector set, said machine also being configured so that the injector sets (14, 16) treat trays placed under these injector sets (14, 16) synchronously or substantially synchronously.

### TECHNICAL FIELD

The present invention relates to a machine for automatic injection of eggs, in particular eggs of birds such as fowl.

It also relates to a method for injecting one or more substances into eggs housed in incubation trays moving over a high-throughput processing line.

### PRIOR ART

It is known in the field of poultry farming, in particular in the production of chicks, to carry out in ovo injections of one or more substances in eggs, in particular in order to reduce mortality or promote embryonic growth.

Examples of injection substances injected comprise vaccines, antibiotics, microorganisms or vitamins.

Such an injection is typically carried out during the transfer of the eggs from the incubation room to the hatching room between the seventeenth and nineteenth day.

During a vaccination in ovo, the shell of the egg is pierced and a dose of vaccine is injected by means of a needle in the amniotic fluid or in the embryo to promote early stimulation of its immune system.

The dose of vaccine injected into each egg is thus advantageously precise and constant.

Such an in ovo injection is carried out after examining of eggs; this method consists of using the optical properties of the eggs to discriminate and ignore during treatment the eggs identified as being not likely to hatch and produce a chick.

The latter are essentially infertile eggs or fertilized eggs but whose egg embryo is dead or else malformed.

This discrimination is also made necessary to avoid the explosion of rotten eggs, which might contaminate not only viable surrounding eggs in the incubation rack, but also the injection material that can be used to inject viable eggs, which would also risk contaminating these eggs.

In addition, such a discrimination makes it possible to minimize the losses of vaccines during in ovo treatment, the non-viable eggs being untreated.

Following this examination step, the incubation rack containing the eggs thus discriminated and positioned vertically with the “large standing”, which is to say with the air chamber in the upper position to ensure good development of the embryo, is moved along a conveying track to a treatment zone of an in ovo injection machine.

This machine typically comprises an egg processing head comprising a set of injectors that are aligned with cells of the incubation case to be treated, each cell containing or not containing an egg to be treated.

This treatment head is movable to move the injectors in a vertical direction, the latter then being moved to come into contact against the upper end of the viable eggs to be injected. Then, a needle or a perforator (“punch”) of each injector in the contact position then pierce the egg for the injection of a treatment substance.

The various steps consisting of moving injectors from this set of injectors to come into contact with the eggs to be treated, to perform the injection into the eggs to be treated and to move these injectors into the raised position, that is to say in the non-contact position with the eggs, constitutes an injection cycle.

The incubation trays typically comprise a large number of cells, for example more than about fifty, which are distributed in rows. These rows, each of which comprises several cells, are for example arranged in a staggered fashion.

The injector assembly of the injection machine typically comprises a plurality of injectors distributed as injection ramps, which are of fixed geometry, being arranged transversely to the conveyor track transporting the incubation trays.

It is noted that the number of injection ramps is however limited so that the injection of the set of eggs to be treated from an incubation rack by an assembly of injectors is carried out in several injection cycles, the tray moving between each cycle to bring under the injectors ramps, new rows of eggs to be treated.

This results in a relatively long treatment time of an incubation rack.

This significant treatment time necessarily has an impact on the maximum rate that the associated treatment line can reach.

The rates observed with these injection machines of the prior art consequently remain low.

There is therefore a pressing requirement for a method for injecting eggs placed in tray cells, the original design of which makes it possible to overcome the disadvantages of the prior art described above.

### SUBJECT MATTER OF THE INVENTION

The present invention aims to overcome the disadvantages of the prior art by proposing a method and a machine for injecting eggs placed in incubation trays, simple in design and in operating mode, offering significantly reduced treatment time.

Another object of the present invention is such a method and such an injection machine allowing extremely fast rates, and by way of illustration, of more than 90,000 eggs per hour.

### DISCLOSURE OF THE INVENTION

To this end, the invention relates to a machine for injecting eggs placed in trays, this machine comprising:
a first injector set for injecting a fluid substance into a first group of eggs in a first tray,
at least one other injector set for injecting a fluid substance into a different group of eggs in another tray,
a treatment line along which the injector sets are arranged, said injector sets being spaced apart from one another such that one injector set treats a single tray at a time,
each injector set being configured to simultaneously treat the eggs to be injected in the corresponding egg group, said tray being stationary during the treatment of said egg group by the corresponding injector set,
said machine also being configured so that the injector sets treat trays placed under these injector sets synchronously or substantially synchronously.

The original design of this machine thus allows faster treatment of egg trays moving along one and the same treatment line. By way of example, treatment rates greater than 90,000 eggs per hour are reached.

Preferably, each set of injectors comprises a number m of rows of injectors, the injectors of a single row being aligned transversely relative to the direction of advance of the trays along said treatment line, the spacing between the injectors of a single row being identical to the distance separating two cells immediately adjacent to a tray in the transverse direction.

It is thus understood that each set of injectors is intended to inject at least some of the eggs, or to treat eggs, which are placed in cells belonging to a specific part of an incubation tray. In this sense, the injectors of this set of injectors are associated with the treatment of a predefined zone of a tray.

Each tray is thus entirely immobile during the treatment of one of its groups of eggs by a corresponding set of injectors. The machine is therefore distinguished from the state of the art according to which the treatment of the same group of eggs of a tray would have required several injection cycles with a tray movement between each injection cycle in order to present new eggs under these injectors. It will be recalled that an injection cycle requiring the lowering of at least some of the injectors in contact position with the corresponding eggs in order to perform an injection, the injection of these eggs and the release into the contactless position of these injectors for the free displacement of the tray, the multiplication of these injection cycles to process a same tray causes a significant slowing of the rate.

The injection of each egg to be treated by an injector is preferably carried out by piercing a hole in the upper surface of the egg by means of an injection needle or a punch configured to pierce the egg, then inject a fluid substance. By way of example, this fluid substance is a non-therapeutic fluid substance such as a nutritional composition, or a fluid comprising one or more active principles for vaccinating.

According to one embodiment of this machine for the injection of eggs, each tray comprising a same number n of groups of eggs with n≥2, the number of sets of injectors arranged along said treatment line is equal to n so that the set of eggs of each tray is treated in n injection cycles.

According to another embodiment of this machine for the injection of eggs, it is configured to simultaneously inject said n groups of eggs into said n trays.

The injection of groups of eggs in parallel by the n sets of injectors and synchronously, or simultaneously, also makes it possible to limit the treatment time of the trays. The rate of the injection machine in ovo is thus increased.

According to yet another embodiment of this machine for the injection of eggs, it comprises only two sets of injectors arranged along said treatment line, a first group of eggs of a tray moving along said treatment line being treated by a first set of injectors, then the tray being moved along the treatment line so as to position the rest of the eggs of this tray to be injected under the second set of injectors for treatment.

An egg tray is thus treated in only two injection cycles and a single passage under each set of injectors. A significant increase in the treatment capacity of the automated line is advantageously observed.

Purely by way of illustration, each set of injectors could be configured to treat eggs housed in one half of a tray.

Alternatively, each set of injectors could be configured to treat a different number of eggs from a single tray with the two sets of injectors making it possible to treat all of the eggs of this tray together.

According to yet another embodiment of this machine for the injection of eggs, at least one of said sets of injectors is configured to have two operating modes, a first mode wherein it is capable of injecting a single group of given eggs of a tray, this tray remaining immobile during the injection of a fluid substance in at least some of the eggs of this group of eggs, and a second mode of operation wherein it is capable of treating all the eggs of a same tray in two injection cycles, the tray being moved between the two cycles to present eggs of this tray not injected under the injectors of said set of injectors.

Advantageously, a redundant system is thus available allowing the continuous operation of the machine in the event of intervention or failure on one of the sets of injectors. Indeed, the assembly of injectors in the operating state, when these sets of injectors are two on the injection machine, is then capable of treating each tray in its entirety at a lower rate.

According to yet another embodiment of this machine for the injection of eggs, this machine comprises stops retractable to immobilize or release a tray in movement at each of these sets of injectors.

According to yet another embodiment of this machine for the injection of eggs, each injector is capable of selectively taking two distinct positions, a contactless position with an egg placed in a tray and a position of contact with this egg to inject a fluid substance so that at least one injector is in this contactless position with a corresponding egg while simultaneously the rest of the injectors of said set of injectors is in a contact position to inject the corresponding eggs.

According to yet another embodiment of this machine for the injection of eggs, this machine comprises means of retention for holding at least one other tray on hold, along said treatment line, upstream of two trays being treated by said first and second sets of injectors

According to yet another embodiment of this machine for the injection of eggs, for each egg to be injected into a group of eggs, the corresponding injector of the set of injectors is capable of aligning individually with this egg prior to carrying out the injection.

According to yet another embodiment of this machine for the injection of eggs, each set of injectors comprises locking elements inflatable to hold the injectors in position during the injection of the eggs.

According to yet another embodiment of this machine for the injection of eggs, it comprises a linear conveyor belt for transporting said trays.

According to a particular embodiment of the present invention, it also relates to a machine for the injection of eggs comprising:
a first set of injectors for injecting a fluid substance into a first group of eggs of a tray,
a second set of injectors for injecting a fluid substance into a second group of eggs, distinct from the first, of this tray,
each injector having one end configured to be in contact with a corresponding egg and comprising a needle and/or a punch for piercing this egg,
this machine comprising a treatment line along which said first and second sets of injectors are arranged by being spaced apart from each other to treat only one tray each,
these two sets of injectors being configured to process together the set of eggs filling a single tray, this tray being immobile during the treatment of each group of eggs by each set of injectors, so that a first group of eggs of a tray moving along said treatment line is first treated by said first set of injectors and then the rest of the eggs of said tray are treated by said second set of injectors.

The invention also relates to a method for injecting at least one fluid substance into eggs, these eggs being placed in incubation trays that are moved along a single treatment line.

According to the invention,
n immediately consecutive incubation trays are positioned on said treatment line, with n≥2, under a plurality of injectors,
injection only in at least some of the eggs belonging to a first group of eggs is carried out in a first of said trays while for each other tray, an injection is carried out only in at least some of the eggs belonging to a distinct group of eggs, each tray being immobile during the treatment of its corresponding group of eggs,
each tray containing said n groups of distinct eggs, at least one group of eggs optionally comprising a different number of eggs between two of said n trays.

In other words, since the eggs are distributed in each tray of a plurality of incubation trays in n groups of distinct eggs, with n≥2, a plurality of immediately consecutive trays are positioned on said treatment line than groups of eggs in each tray, and an injection is carried out in at least some of the eggs belonging to a single one of said groups in a first of said trays while an injection is carried out in at least some of the eggs belonging to a distinct group in each other tray, each tray being immobile during the treatment of its corresponding group of eggs.

Advantageously, this injection method in ovo thus makes it possible to treat all of the eggs to be injected from n separate trays, with n≥2, moving along a single treatment line, in only n injection cycles using n sets of injectors configured to each treat at most one of the groups of eggs in a tray.

All the eggs of a given tray are thus treated by a single passage under each set of injectors, the tray being immobile during the treatment of each corresponding group of eggs.

Of course, it is assumed that these incubation trays moving along the same treatment line are structurally identical or that a tray different from these other trays comprises fewer rows of cells but with the same arrangement of the rows as these other trays.

Thus, and in a particular embodiment wherein two or three incubation trays would be treated according to the method for injecting at least one fluid substance, object of this document:
two, or respectively three, incubation trays are positioned on said treatment line, under a plurality of injectors, and injection only in at least some of the eggs belonging to a first group of eggs is carried out in a first of said trays while an injection is carried out only in at least some of the eggs belonging to a distinct group of eggs in each other tray, each tray being immobile during the treatment of its corresponding group of eggs, the set of eggs positioned in each tray being formed by these two, or respectively three, only groups of distinct eggs.

According to a particular embodiment of this method for injecting at least one fluid substance, a first tray being placed downstream of the (n-1) other trays along said treatment line and the set of its eggs to be treated having been treated, the following additional steps are carried out:
moving said first tray along said treatment line,
moving the (n-1) trays along said treatment line as well as a new tray, placed immediately adjacent and upstream of these (n-1) trays, along said treatment line, so as to position each of these trays under said plurality of injectors and inject a fluid substance into a group of eggs that are not yet injected from each of these trays.

According to another particular embodiment of this method for injecting at least one fluid substance, the injections of the eggs belonging to distinct groups of said trays placed under said plurality of injectors are carried out simultaneously.

This ensures perfect synchronization of the parallel injections of the egg trays so as to optimize their treatment and maximize the rate of the automated treatment line.

According to yet another embodiment of this method for injecting at least one fluid substance, said plurality of injectors defining a first set of injectors for injecting a fluid substance into a first group of eggs of a tray and a second set of injectors for injecting a fluid substance into a second group of eggs of another tray, the set of eggs of a single tray is processed by a single passage under each set of injectors, the tray being immobile during the treatment of each corresponding group of eggs.

These two sets of injectors are thus advantageously configured to treat together the set of eggs to be injected of a tray so that a first group of eggs of this tray is first treated by the first set of injectors, then the tray is moved along the treatment line to position the rest of the eggs of this tray to be injected under the second set of injectors.

According to yet another embodiment of this method for injecting at least one fluid substance, the eggs of each tray being received in cavities of the tray defining even and odd rows, at least some of the eggs of the even, odd rows are injected from the first tray while at least some of the eggs of the odd rows, or respectively pairs, of the second tray are injected.

This is an example of distribution of the eggs of an incubation tray into two particularly simple groups: the eggs positioned in even rows and the eggs positioned in odd rows. Alternatively, it could also be eggs positioned in a first half of the incubation tray and eggs positioned in the other half of this tray.

Of course, this distribution of the eggs to be injected into each incubation tray could be more complex with a division of the tray into three not necessarily equal areas. For example, a tray comprising nine rows of six eggs each could be treated by three sets of injectors (treatment in three injection cycles), each set of injectors treating three distinct rows of the tray.

According to yet another embodiment of this method for injecting at least one fluid substance, during the treatment of these n trays, at least one other egg bed placed upstream of these n trays, along said treatment line, is kept immobile.

Another incubation tray is thus awaiting treatment.

According to yet another embodiment of this method for injecting at least one fluid substance, for each egg to be injected, the corresponding injector of said plurality of injectors is individually aligned with this egg prior to carrying out the injection.

According to yet another embodiment of this method for injecting at least one fluid substance, each tray comprising cells for receiving eggs, at least one injector of said plurality of injectors, under which a cell of a tray containing or not containing an egg of said group of eggs corresponding to treat is positioned, is held in a contactless position during a treatment sequence so that at least this injector is in this contactless position with the corresponding egg while simultaneously the rest of the injectors of said plurality of injectors are in a contact position to inject the corresponding eggs.

Advantageously, such an embodiment avoids contacting the end of an injector with a non-viable egg detected beforehand by examining. The risk of contamination of viable eggs surrounding a rotten egg with explosion of the latter is thus greatly reduced.

According to yet another embodiment of this method for injecting at least one fluid substance, said trays are transported on a linear conveyor belt.

According to yet another embodiment of this method for injecting at least one fluid substance, said injectors are held in position by pneumatic locking elements during the injection of the eggs.

### BRIEF DESCRIPTION OF THE DRAWINGS

Other advantages, aims and particular features of the present invention will become apparent from the following description, made, for explanatory purposes and in no way limiting, with reference to the appended drawings, in which:

FIG. 1 is a schematic representation of an in ovo injection machine according to a particular embodiment of the present invention, a first incubation tray being awaiting injection at the inlet of this machine;

FIG. 2 shows the injection machine of FIG. 1 wherein a first group of eggs in the first incubation tray is treated by a first set of injectors while a second tray is awaiting treatment at the inlet of the machine;

FIG. 3 shows the injection machine of FIG. 1 wherein the rest of the non-injected eggs of the first incubation tray are treated by a second set of injectors of this machine while the first group of eggs in the second incubation tray is injected by the first set of injectors, a third tray being awaiting treatment at the inlet of the machine;

### DESCRIPTION OF EMBODIMENTS

The drawings and the following description essentially contain elements of a certain nature. They may therefore not only serve to better understand the present invention, but also contribute to its definition, where appropriate.

First, it should be noted that the figures are not to scale.

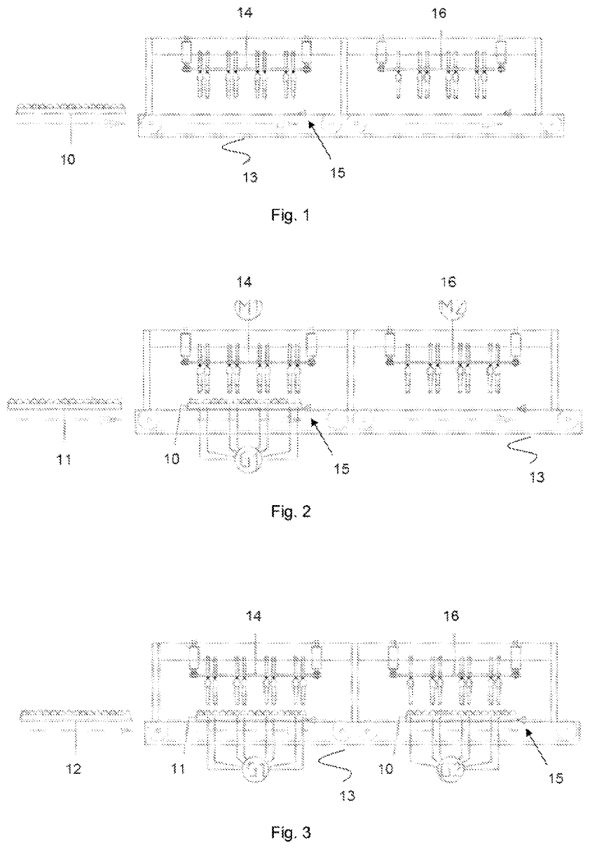

FIGS. 1 to 3 schematically show the various steps leading to the injection of a substance into fowl eggs filling two displacement incubation trays along a same treatment line at a high rate.

The eggs are distributed in rows and columns in the cells of each incubation tray 10-12 which are here of the “rectangular” type, each tray comprising fifteen (15) rows of ten (10) cells each, i.e. one hundred and fifty (150) eggs per tray.

These eggs are thus divided into two groups to be treated by the injection machine, a first group of eggs G₁ comprising eight (8) rows of eggs located in a first part of the tray and a second group of eggs G₂ housed in the rest of the cells of this tray, i.e. seven (7) rows.

The eggs of these incubation trays 10-12 are treated on an in ovo injection machine comprising a treatment line defined by a linear conveyor 13 such as a belt conveyor. This linear conveyor 13 transports the incubation trays along the machine.

After an examining step making it possible to identify the eggs of each tray to be injected and those not to be treated, a first tray 10 is placed under a first set of injectors 14 of this machine.

This first set of injectors 14 comprises an injection head supporting a number of injectors equal to the number of cells present in all rows of the first group G₁ of this incubation tray.

Thus, and for each row of eggs of this first group, the first set of injectors 14 comprises a number of injectors corresponding to the number of cells in the row considered, which are arranged transversely to the direction of movement of the conveyor, these injectors being spaced apart by the distance separating the cells from one another.

Each injector is also capable of selectively taking two distinct positions, a contactless position with an egg placed in this tray 10 and a position of contact with this egg to inject a fluid substance.

Each injector also comprises at its end a cup (not shown) whose shape allows contact with a corresponding egg, and a needle for piercing this egg.

The machine comprises a central unit (not shown) receiving the state signals from each egg of the first tray 10 coming from the examining step and allowing from these state signals to determine the position that each injector must take of this first set of injectors 14 relative to the egg contained in the corresponding cell to this injector of the tray 10.

This first set of injectors 14 thus makes it possible to inject a fluid substance into at least some of the eggs in the first group of eggs G₁ of this tray 10 while not treating the non-viable eggs of this group.

A retractable stop 15 makes it possible to immobilize or release the tray 10 moving along the conveyor 13 at this first set of injectors 14.

During the treatment of the eggs of this first group of eggs G₁, this first incubation tray 10 is immobile while being blocked in its movement by the retractable stop 15.

As shown in FIG. 3, once the first group of eggs G₁ of this first treated tray 10, this first incubation tray 10 is released by moving the retractable stop 15 in the non-active position. This first incubation tray 10 transported by the linear conveyor 13 is then moved to a second set of injectors 16.

Another retractable stop 15 is placed in the active position to stop the first tray 10 under the injectors of the second set of injectors 16.

In parallel, the non-injected eggs of the first group of eggs G₁ of a second tray 11 are placed under the injectors of the first set of injectors 14.

These first and second sets of injectors 14, 16 are spaced apart from each other along the conveyor 13 to ensure the parallel treatment of two separate trays 10, 11.

This second set of injectors 16 is configured to inject a fluid substance into the eggs belonging to the second group of eggs G₂ of the first tray 10.

Depending on the data obtained during the prior step of examining, at least some of the eggs belonging to the first group of eggs G₁ of the second tray 11 are injected while simultaneously, at least some of the eggs belonging to the second group of eggs G₂ of the first tray 10 are also processed.

Thus, the set of eggs to be treated from the first tray 10 were injected before the latter leaves the injection machine in ovo.

During this time, a third tray 12 of fowl eggs is placed waiting at the inlet of the injection machine in ovo.

Advantageously, the spacing between the two sets of injectors 14, 16 is determined to facilitate the maintenance of the machine.

1. A machine for injecting eggs placed in trays, said machine comprising: a first injector set (14) for injecting a fluid substance into a first group of eggs in a first tray and at least one other injector set (16) for injecting a fluid substance into a different group of eggs in another tray, said machine also comprising a treatment line along which the injector sets are arranged, said injector sets (14, 16) being spaced apart from one another such that one injector set treats a single tray at a time, each injector set (14, 16) being configured to simultaneously treat the eggs to be injected in the corresponding egg group, said tray being stationary during the treatment of said egg group by the corresponding injector set, said machine also being configured so that the injector sets (14, 16) treat trays placed under these injector sets (14, 16) synchronously or substantially synchronously.

2. A machine for the injection of eggs according to claim 1, characterized in that each tray comprising a same number n of groups of eggs with n≥2, the number of sets of injectors arranged along said treatment line is equal to n such that the set of eggs of each tray is treated in n injection cycles.

3. A machine for the injection of eggs according to claim 1, characterized in that it comprises only two sets of injectors arranged along said treatment line, a first group of eggs of a tray moving along said treatment line being treated by a first set of injectors and then the tray being moved along the treatment line so as to position the rest of the eggs of this tray to be injected under the second set of injectors for treatment.

4. A machine for the injection of eggs according to claim 1, characterized in that at least one of said sets of injectors is configured to have two operating modes, a first mode wherein it is capable of treating a single group of given eggs of a tray, this tray remaining immobile during the injection of a fluid substance in at least some of the eggs of this group of eggs, and a second mode of operation wherein it is capable of treating all the eggs of a same tray in two injection cycles, the tray being moved between the two cycles to present eggs of this tray not injected under the injectors of said set of injectors.

5. A machine for the injection of eggs according to claim 1, characterized in that said machine comprises retractable stops (15) for immobilizing or releasing a moving tray along said treatment line at each of these sets of injectors.

6. An egg injection machine according to claim 1, characterized in that it is configured so that each injector is capable of selectively taking two distinct positions, a contactless position with an egg placed in a tray and a contact position with this egg to inject a fluid substance.

7. A machine for the injection of eggs according to claim 1, characterized in that each set of injectors comprises locking elements inflatable to hold the injectors in position during the injection of the eggs.

8. A method for injecting at least one non-therapeutic fluid substance into eggs, these eggs being placed in incubation trays which are moved along a same treatment line (13), characterized in that
n incubation trays (10-12) immediately consecutive on said treatment line (13) are positioned, with n≥2, under a plurality of injectors,
injection is carried out only in at least some of the eggs belonging to a first group of eggs in a first of said trays (10), while for each other tray (11, 12), an injection is carried out only in at least some of the eggs belonging to a distinct group of eggs, each tray (10-12) being immobile during the treatment of its corresponding group of eggs,
each tray containing said n groups of distinct eggs, at least one group of eggs optionally comprising a different number of eggs between two of said n trays.

9. The injection method according to claim 8, characterized in that a first tray being placed downstream of the (n-1) other trays along said treatment line and the set of its eggs to be treated having been treated, the following additional steps are carried out:
moving said first tray along said treatment line,
moving the (n-1) trays along said treatment line as well as a new tray, placed immediately adjacent and upstream of these (n-1) trays, along said treatment line, so as to position each of these trays under said plurality of injectors and inject a fluid substance into a group of eggs that are not yet injected from each of these trays.

10. The injection method according to claim 8, characterized in that the injections of the eggs belonging to distinct groups of said trays placed under said plurality of injectors are carried out simultaneously.

11. The injection method according to claim 8, characterized in that said plurality of injectors defining a first set of injectors (14) for injecting a fluid substance into a first group of eggs of a tray and a second set of injectors (16) for injecting a fluid substance into a second group of eggs of another tray, the set of eggs of a tray is processed by a single passage under each set of injectors, the tray being immobile during the treatment of each corresponding group of eggs.

12. The injection method according to claim 8, characterized in that each tray comprising cells for receiving eggs, which are arranged in even and odd rows, at least some of the eggs of the even or odd rows are injected from a first tray while at least some of the eggs of the odd rows, or respectively pairs, of another tray are injected.

13. The injection method according to claim 8, characterized in that during the treatment of these n trays, at least one other egg bed placed upstream of these n trays along said treatment line is kept immobile.

14. The injection method according to claim 8, characterized in that for each egg to be injected, the corresponding injector of said plurality of injectors is individually aligned with this egg prior to carrying out the injection.

15. The injection method according to claim 8, characterized in that each tray comprising cells for receiving eggs, at least one injector of said plurality of injectors, under which a cell of a tray containing or not containing an egg of said group of eggs corresponding to treatment, is positioned, is held in a contactless position during a treatment sequence so that at least this injector is in this contactless position with the corresponding egg while simultaneously the other injectors of said plurality of injectors are in a contact position to inject the corresponding eggs.
